(19) United States
(12) Patent Application Publication
(10) Pub. No.: US 2011/0097154 A1
(43) Pub. Date: Apr. 28, 2011

(54) Pressure Release Apparatus Having A Hydraulic Generating Function

(76) Inventor: Yu-Lin Chu, Tainan City (TW)

(21) Appl. No.: 12/606,359

(22) Filed: Oct. 27, 2009

(51) Int. Cl. E02B 9/00; F03B 13/10

(52) U.S. Cl. 405/75; 290/54

(57) ABSTRACT

A pressure release apparatus includes a water tower, a plurality of water supply pipes, a plurality of pressure release units and a plurality of generating units. Each of the generating units includes a generator and a collector. Each of the pressure release units includes two propeller shafts each connected with the generator of the respective generating unit to drive the generator to generate an electric power, and two impellers each secured on the respective propeller shaft to rotate the respective propeller shaft. Thus, the pressure release units co-operate with the generating units to provide a water pressure release effect and an electric generating function simultaneously.

### BACKGROUND OF THE INVENTION

1. Field of the Invention

The present invention relates to a pressure release apparatus and, more particularly, to a pressure release apparatus for a water supply system of a building.

2. Description of the Related Art

A conventional pressure release apparatus comprises a water tower, a plurality of water supply pipes each connected with the water tower, and a plurality of pressure release units each mounted on a respective one of the water supply pipes. In operation, when the water in the water tower is delivered through each of the water supply pipes to the respective pressure release unit, the respective pressure release unit is operated to counteract the impact of the water to reduce the water pressure in each of the water supply pipes so as to achieve a pressure release purpose to each of the water supply pipes. However, the conventional pressure release apparatus only has a single pressure release function, thereby limiting the versatility of the conventional pressure release apparatus.

### BRIEF SUMMARY OF THE INVENTION

In accordance with the present invention, there is provided a pressure release apparatus, comprising a water tower, a plurality of water supply pipes each connected with the water tower, a plurality of pressure release units each mounted on a respective one of the water supply pipes, and a plurality of generating units each connected with a respective one of the pressure release units. Each of the generating units includes a generator connected with and driven by the respective pressure release unit to generate an electric power and a collector connected with the generator to collect and store the electric power from the generator.

In accordance with one embodiment of the present invention, each of the pressure release units includes two propeller shafts each connected with the generator of the respective generating unit to drive the generator of the respective generating unit to generate the electric power, and two impellers each secured on a respective one of the propeller shafts to drive and rotate the respective propeller shaft relative to the generator of the respective generating unit. Each of the propeller shafts of each of the pressure release units is perpendicular to the respective water supply pipe. The impellers of each of the pressure release units are spaced from each other, and a center line of each of the water supply pipes is located between the impellers of the respective pressure release unit. The impellers of each of the pressure release units are images relative to each other about the center line of the respective water supply pipe. Each of the impellers of each of the pressure release units is perpendicular to the respective water supply pipe.

In accordance with another embodiment of the present invention, each of the pressure release units includes two first propeller shafts each connected with the generator of the respective generating unit to drive the generator of the respective generating unit to generate the electric power, two first bevel gears each secured on a respective one of the first propeller shafts to drive and rotate the respective first propeller shaft, a second propeller shaft rotatably mounted in the respective water supply pipe, an impeller secured on the second propeller shaft to drive and rotate the second propeller shaft, and a second bevel gear secured on and rotated by the second propeller shaft and meshing with the first bevel gears to drive and rotate the first bevel gears. The second propeller shaft of each of the pressure release units is parallel with the respective water supply pipe. The impeller of each of the pressure release units is parallel with the respective water supply pipe. The impeller of each of the pressure release units is located at a central position of the respective water supply pipe. Each of the first propeller shafts of each of the pressure release units is perpendicular to the respective water supply pipe.

The primary objective of the present invention is to provide a pressure release apparatus having a hydraulic generating function.

According to the primary objective of the present invention, the pressure release units co-operate with the generating units to provide a water pressure release effect and an electric generating function simultaneously.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a pressure release apparatus in accordance with the preferred embodiment of the present invention.

FIG. 2 is a partially broken exploded perspective cross-sectional view of the pressure release apparatus as shown in FIG. 1.

FIG. 3 is a schematic operational view of the pressure release apparatus as shown in FIG. 2 in use.

FIG. 4 is a locally enlarged front cross-sectional view of the pressure release apparatus in accordance with another preferred embodiment of the present invention.

FIG. 5 is a partially broken exploded perspective cross-sectional view of the pressure release apparatus in accordance with another preferred embodiment of the present invention.

FIG. 6 is a schematic operational view of the pressure release apparatus as shown in FIG. 5 in use.

### DETAILED DESCRIPTION OF THE INVENTION

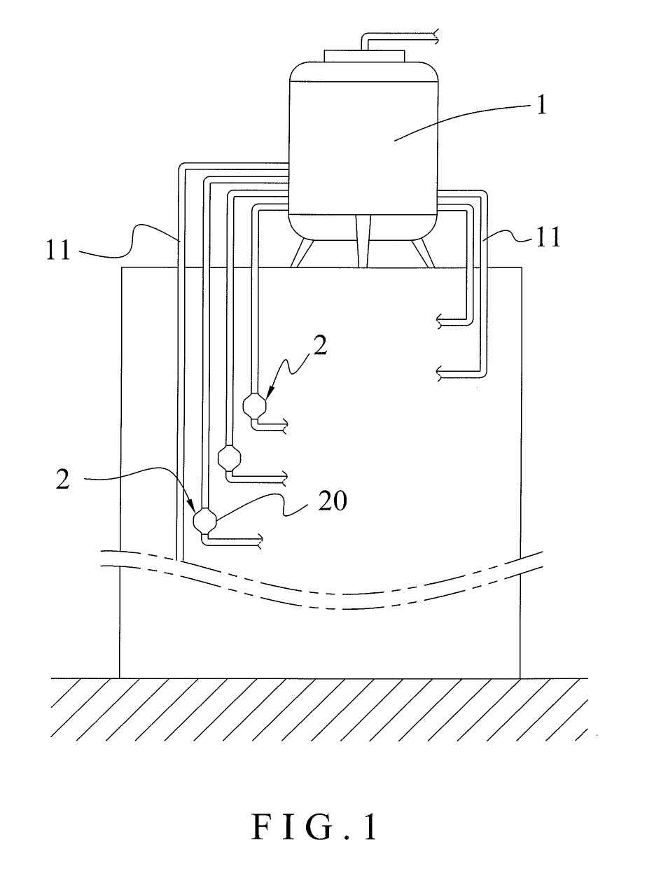

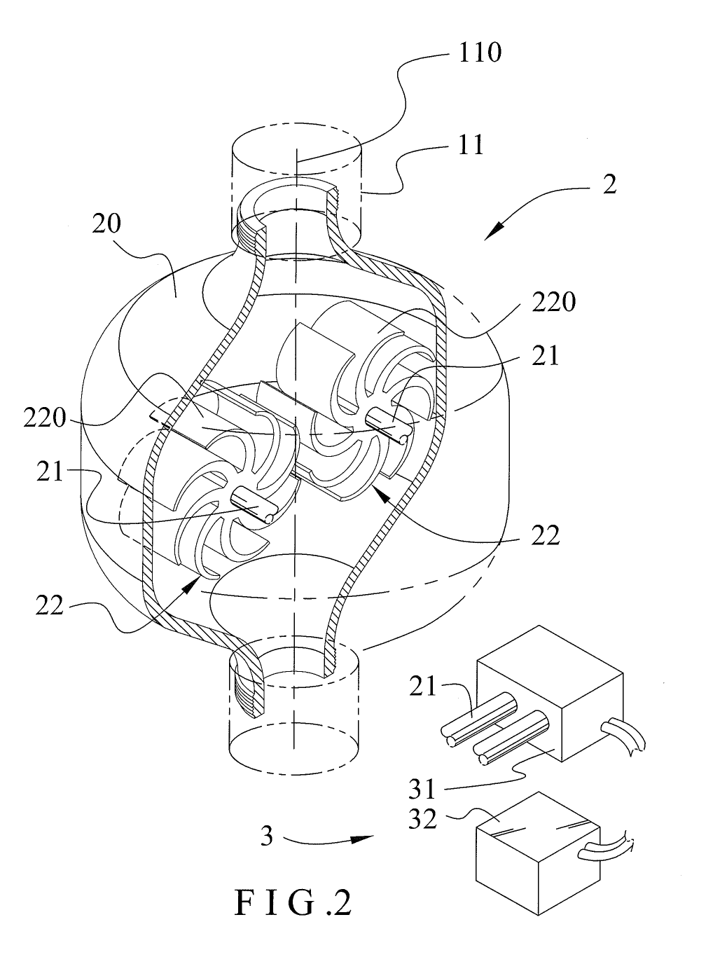

Referring to the drawings and initially to FIGS. 1 and 2, a pressure release apparatus in accordance with the preferred embodiment of the present invention comprises a water tower 1, a plurality of water supply pipes 11 each connected with the water tower 1, a plurality of pressure release units 2 each mounted on a respective one of the water supply pipes 11, and a plurality of generating units 3 each connected with a respective one of the pressure release units 2.

Each of the generating units 3 includes a generator 31 connected with and driven by the respective pressure release unit 2 to generate an electric power and a collector 32 connected with the generator 31 to collect and store the electric power from the generator 31.

Each of the pressure release units 2 is located beneath the water tower 1 and includes two propeller shafts 21 each connected with the generator 31 of the respective generating unit 3 to drive the generator 31 of the respective generating unit 3 to generate the electric power, two impellers 22 each secured on a respective one of the propeller shafts 21 to drive and rotate the respective propeller shaft 21 relative to the generator 31 of the respective generating unit 3, and a housing 20 mounted on the respective water supply pipe 11 to receive the propeller shafts 21 and the impellers 22.

Each of the propeller shafts 21 of each of the pressure release units 2 is rotatably mounted in the housing 20. Each of the propeller shafts 21 of each of the pressure release units 2 is perpendicular to the respective water supply pipe 11 and has a first end secured to and rotated by the respective impeller 22 and a second end rotatably mounted on the generator 31 of the respective generating unit 3.

Each of the impellers 22 of each of the pressure release units 2 is rotatably mounted in the housing 20. The impellers 22 of each of the pressure release units 2 are spaced from each other so that a center line 110 of each of the water supply pipes 11 is located between the impellers 22 of the respective pressure release unit 2. The impellers 22 of each of the pressure release units 2 are images relative to each other about the center line 110 of the respective water supply pipe 11. Each of the impellers 22 of each of the pressure release units 2 is perpendicular to the respective water supply pipe 11 and consists of a plurality of arc-shaped blades 220 each extending radially and outwardly from the respective propeller shaft 21.

Thus, each of the propeller shafts 21 of each of the pressure release units 2 is rotated to produce a mechanic power which is transmitted to the generator 31 of the respective generating unit 3, and the generator 31 of the respective generating unit 3 transfers the mechanic power into an electric power which is collected and stored in the collector 32 of the respective generating unit 3.

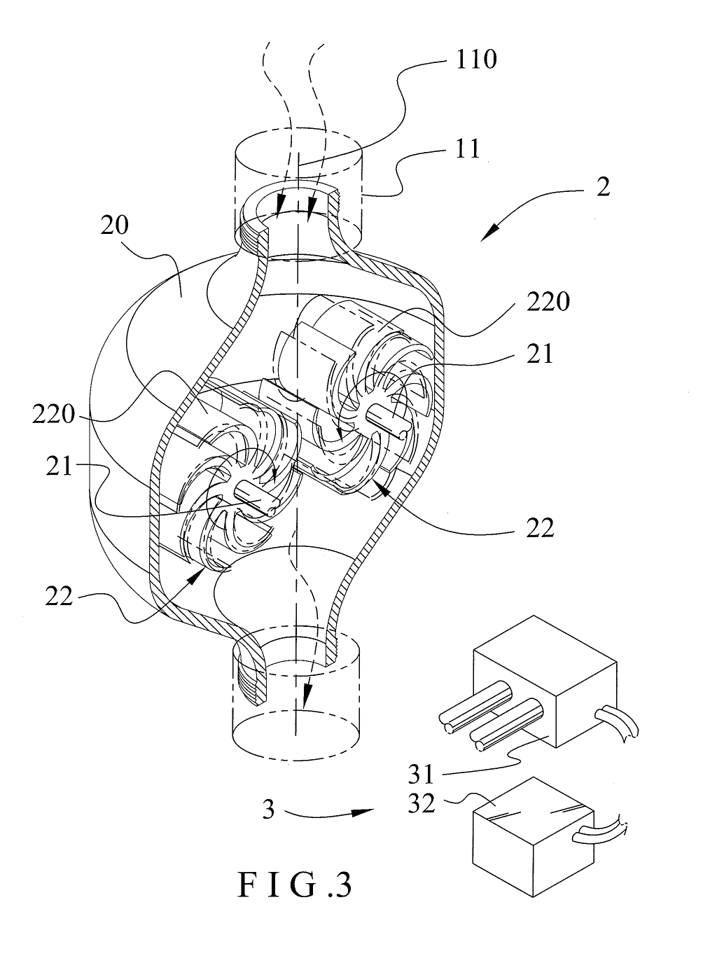

In operation, referring to FIG. 3 with reference to FIGS. 1 and 2, when the water in the water tower 1 is delivered through each of the water supply pipes 11 to pass the gap between the impellers 22 of the respective pressure release unit 2, the impellers 22 of the respective pressure release unit 2 are rotated to counteract the impact of the water to reduce the water pressure in each of the water supply pipes 11 so as to achieve a pressure release purpose to each of the water supply pipes 11. At the same time, each of the propeller shafts 21 of each of the pressure release units 2 is rotated by rotation of each of the impellers 22 to produce a mechanic power which is transmitted to the generator 31 of the respective generating unit 3, and the generator 31 of the respective generating unit 3 transfers the mechanic power into an electric power which is collected and stored in the collector 32 of the respective generating unit 3. Thus, the pressure release units 2 can co-operate with the generating units 3 to provide a water pressure release effect and an electric generating function simultaneously.

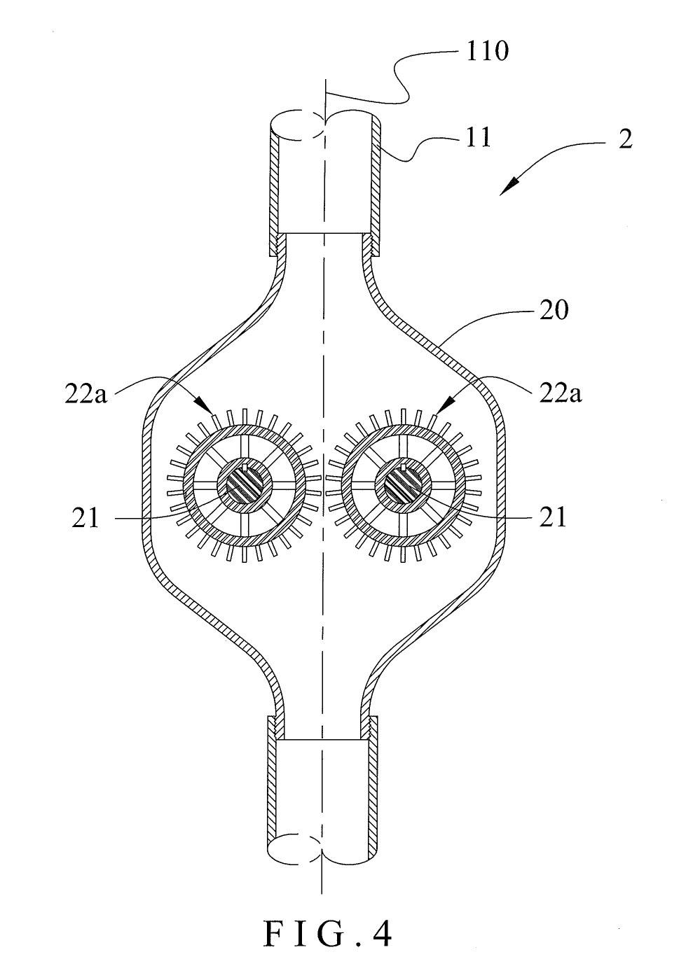

As shown in FIG. 4, each of the impellers 22a of each of the pressure release units 2 has a watermill shape.

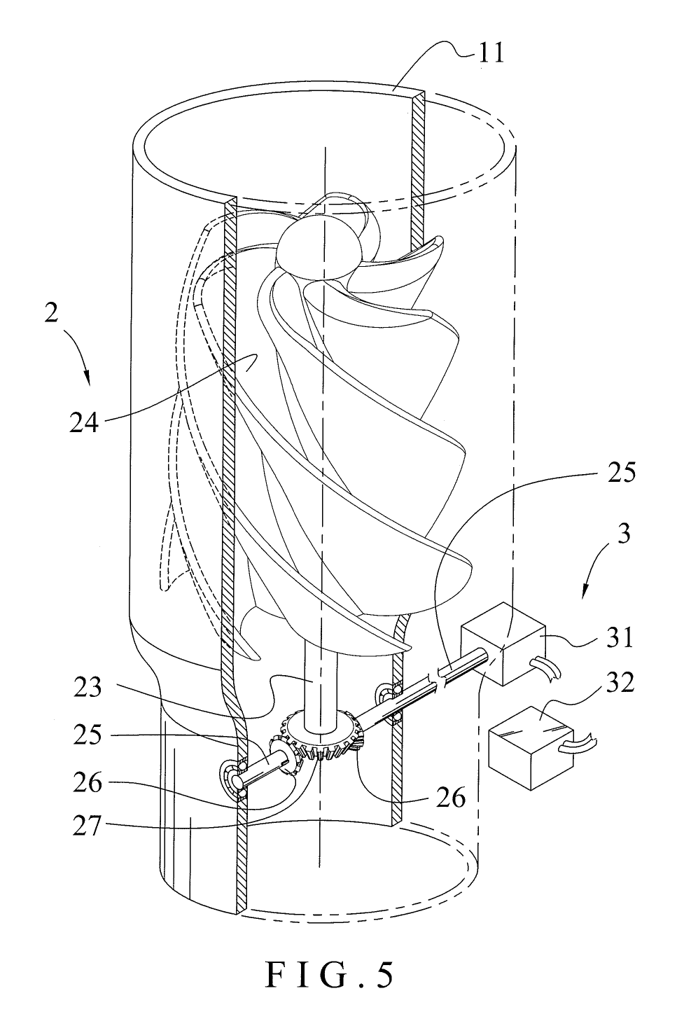

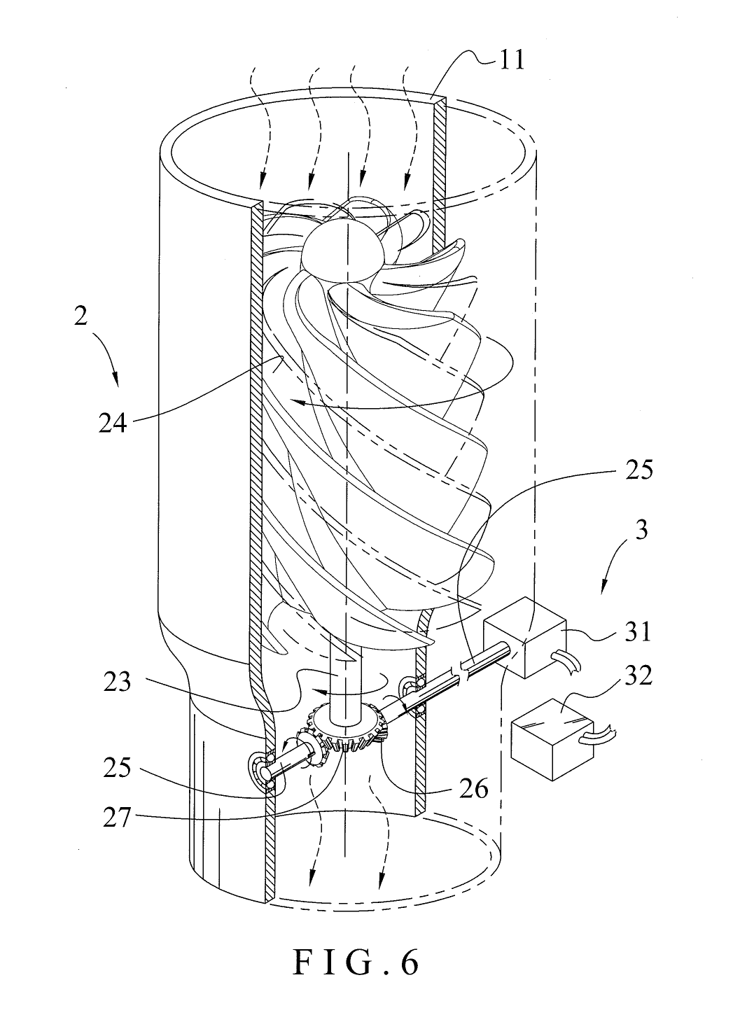

Referring to FIGS. 5 and 6, each of the pressure release units 2 includes two first propeller shafts 25 each connected with the generator 31 of the respective generating unit 3 to drive the generator 31 of the respective generating unit 3 to generate the electric power, two first bevel gears 26 each secured on a respective one of the first propeller shafts 25 to drive and rotate the respective first propeller shaft 25, a second propeller shaft 23 rotatably mounted in the respective water supply pipe 11, an impeller 24 secured on the second propeller shaft 23 to drive and rotate the second propeller shaft 23, and a second bevel gear 27 secured on and rotated by the second propeller shaft 23 and meshing with the first bevel gears 26 to drive and rotate the first bevel gears 26. The second propeller shaft 23 of each of the pressure release units 2 is parallel with the respective water supply pipe 11. The impeller 24 of each of the pressure release units 2 is parallel with the respective water supply pipe 11 and has a helical and conical shape. The impeller 24 of each of the pressure release units 2 is located at a central position of the respective water supply pipe 11. Each of the first propeller shafts 25 of each of the pressure release units 2 is perpendicular to the respective water supply pipe 11. Thus, at least one of the first propeller shafts 25 of each of the pressure release units 2 is rotated to produce a mechanic power which is transmitted to the generator 31 of the respective generating unit 3, and the generator 31 of the respective generating unit 3 transfers the mechanic power into an electric power which is collected and stored in the collector 32 of the respective generating unit 3.

In operation, referring to FIG. 6 with reference to FIGS. 1 and 5, when the water in the water tower 1 is delivered through each of the water supply pipes 11 to pass the respective pressure release unit 2, the impeller 24 of the respective pressure release unit 2 is rotated to counteract the impact of the water to reduce the water pressure in each of the water supply pipes 11 so as to achieve a pressure release purpose to each of the water supply pipes 11. At the same time, the second propeller shaft 23 of each of the pressure release units 2 is rotated by rotation of each of the impeller 24 to rotate the first propeller shafts 25 by intermeshing of the second bevel gear 27 and the first bevel gears 26 to produce a mechanic power which is transmitted to the generator 31 of the respective generating unit 3, and the generator 31 of the respective generating unit 3 transfers the mechanic power into an electric power which is collected and stored in the collector 32 of the respective generating unit 3. Thus, the pressure release units 2 can co-operate with the generating units 3 to provide a water pressure release effect and an electric generating function simultaneously.

Accordingly, the pressure release units 2 can co-operate with the generating units 3 to provide a water pressure release effect and an electric generating function simultaneously.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pressure release apparatus, comprising:
a water tower;
a plurality of water supply pipes each connected with the water tower;
a plurality of pressure release units each mounted on a respective one of the water supply pipes;
a plurality of generating units each connected with a respective one of the pressure release units.

2. The pressure release apparatus of claim 1, wherein each of the generating units includes:
a generator connected with and driven by the respective pressure release unit to generate an electric power;
a collector connected with the generator to collect and store the electric power from the generator.

3. The pressure release apparatus of claim 2, wherein each of the pressure release units includes:
two propeller shafts each connected with the generator of the respective generating unit to drive the generator of the respective generating unit to generate the electric power;
two impellers each secured on a respective one of the propeller shafts to drive and rotate the respective propeller shaft relative to the generator of the respective generating unit.

4. The pressure release apparatus of claim 3, wherein each of the propeller shafts of each of the pressure release units is perpendicular to the respective water supply pipe.

5. The pressure release apparatus of claim 3, wherein each of the propeller shafts of each of the pressure release units has a first end secured to and rotated by the respective impeller and a second end rotatably mounted on the generator of the respective generating unit.

6. The pressure release apparatus of claim 3, wherein
the impellers of each of the pressure release units are spaced from each other;
a center line of each of the water supply pipes is located between the impellers of the respective pressure release unit.

7. The pressure release apparatus of claim 6, wherein the impellers of each of the pressure release units are images relative to each other about the center line of the respective water supply pipe.

8. The pressure release apparatus of claim 3, wherein each of the impellers of each of the pressure release units is perpendicular to the respective water supply pipe.

9. The pressure release apparatus of claim 3, wherein each of the impellers of each of the pressure release units consists of a plurality of arc-shaped blades each extending radially and outwardly from the respective propeller shaft.

10. The pressure release apparatus of claim 3, wherein each of the impellers of each of the pressure release units 2 has a watermill shape.

11. The pressure release apparatus of claim 1, wherein each of the pressure release units is located beneath the water tower.

12. The pressure release apparatus of claim 3, wherein each of the pressure release units further includes:
a housing mounted on the respective water supply pipe to receive the propeller shafts and the impellers.

13. The pressure release apparatus of claim 12, wherein each of the propeller shafts of each of the pressure release units is rotatably mounted in the housing.

14. The pressure release apparatus of claim 12, wherein each of the impellers of each of the pressure release units is rotatably mounted in the housing.

15. The pressure release apparatus of claim 2, wherein each of the pressure release units includes:
two first propeller shafts each connected with the generator of the respective generating unit to drive the generator of the respective generating unit to generate the electric power;
two first bevel gears each secured on a respective one of the first propeller shafts to drive and rotate the respective first propeller shaft;
a second propeller shaft rotatably mounted in the respective water supply pipe;
an impeller secured on the second propeller shaft to drive and rotate the second propeller shaft;
a second bevel gear secured on and rotated by the second propeller shaft and meshing with the first bevel gears to drive and rotate the first bevel gears.

16. The pressure release apparatus of claim 15, wherein the second propeller shaft of each of the pressure release units is parallel with the respective water supply pipe.

17. The pressure release apparatus of claim 15, wherein the impeller of each of the pressure release units is parallel with the respective water supply pipe.

18. The pressure release apparatus of claim 15, wherein the impeller of each of the pressure release units has a helical and conical shape.

19. The pressure release apparatus of claim 15, wherein the impeller of each of the pressure release units is located at a central position of the respective water supply pipe.

20. The pressure release apparatus of claim 15, wherein each of the first propeller shafts of each of the pressure release units is perpendicular to the respective water supply pipe.
